(19) United States
(12) Patent Application Publication
(10) Pub. No.: US 2007/0056022 A1
(43) Pub. Date: Mar. 8, 2007

(54) Two-factor authentication employing a user's IP address

(75) Inventor: Uzi Dvir, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Aladdin Knowledge Systems Ltd., Tel Aviv (IL)

(21) Appl. No.: 11/462,048

(22) Filed: Aug. 3, 2006

Related U.S. Application Data
(60) Provisional application No. 60/704,908, filed on Aug. 3, 2005.

(51) Int. Cl. H04L 9/32; G06K 9/00; G06F 17/30; G06F 15/16; G06F 7/04; G06F 7/58; G06K 19/00

(52) U.S. Cl. 726/4; 726/5; 726/6; 726/7

(57) ABSTRACT

A method, system and computer-readable code for providing authentication services. In some embodiments, an attempt is made to match an IP address associated with a service and/or authentication request and user details of the request with an ISP account. In exemplary embodiments, if there is an indication that the IP address was issued by an ISP to a user matching the user details, the user is authenticated. In exemplary embodiments, a database of allowable dynamic and/or static IPs is maintained, and users are authenticated in accordance with contents of the maintained database. Systems, methods and computer-readable code for maintaining a database of allowable IPs are disclosed herein.

### CROSS-REFERENCE TO RELATED APPLICATIONS

This patent application claims the benefit of U.S. Provisional Patent Application No. 60/704,908 filed Aug. 3, 2005 by the present inventor.

### FIELD OF THE INVENTION

The present invention relates to methods and systems for multi-factor authentication of users.

### BACKGROUND AND RELATED ART

Two-Factor Authentication

User ID and password often is required in order for a suspect user to gain access from an access authority to an online-service and/or network resource. The access authority may comprise a server of the computer network, which grants access once the user ID has been authenticated using the password received from the suspect user. Moreover, the access authority may include security privileges for granting specific types of access by authenticated users, and the access authority may additionally perform the authentication of suspect users.

The increasing number of systems each requiring a user ID and password in order for a suspect user to gain access to a network resource ultimately confuses users. To reduce confusion, users typically choose easy-to-remember-passwords. Otherwise, users tend to forget complex passwords and record the passwords in easily accessible areas for later reference. For example, many users maintain a list of user IDs and passwords in a spreadsheet or text file on their computer or personal digital assistant. Programs even have been written to help maintain user ID and password combinations.

Enterprises, such as corporations, Internet service providers, portals, application service providers (ASPs), e-commerce providers, online financial services, etc., must manage user IDs and passwords for their users. Allowing users to employ simple passwords reduces security at a time when security attacks are increasing and are increasingly expensive when they occur. On the other hand, enforcing the use of complex passwords and requiring passwords to be changed frequently increases security, but also increases cost in the form of help desk and customer service calls for the resetting of passwords. The systems that have been developed to allow users to use personal information to reset a password automatically without human intervention tend to be less secure because personal information can be guessed or obtained surreptitiously. Some systems, for example, use information from credit reports—despite the fact that credit bureaus are in the business of proactively selling that information.

Multi-factor authentication systems which provide an additional layer of security are known in the art. For example, hardware tokens such as Aladdin's USB tokens and RSA Security's time-based one-time password tokens are now being utilized in some multi-factor authentication systems wherein these tokens are able to uniquely identify themselves. One salient feature associated with many multi-factor authentication systems is the requirement that the user has physical possession of, i.e., the token, in addition to something the user knows, i.e., the password.

Another example of a multi-factor authentication system is based on biometric authentication of the user. Here too authentication is based on physical data associated with the user.

Another common example of two-factor authentication is a bank card (credit card, debit card); the card itself is the physical item associated with/possessed by the user, and the personal identification number (PIN) is the data that goes with it.

The aforementioned security tokens and biometric systems are effective in a variety of situations and for many users. Nevertheless, in certain situations it is desired to provide yet an additional layer of security. Furthermore, certain users prefer to avoid biometric authentication, and certain users consider the aforementioned tokens to be impractical for various reasons (for example, the tokens may be subject to loss).

Thus, there is an ongoing need for new multi-factor authentication methods, systems and protocols that provide additional security and/or an alternative for situations where physical multi-factor authentication devices are not used.

Published patent documents relating to two-factor and multi-factor authentications include U.S. Pat. No. 6,557,104, US 2004/0187018, and US 2005/0245257.

### Access to a Wide-Area Network Provided by ISPs

To date, most home users and many business users of the Internet connect to the Internet using either a dial-up connection, or a broadband access such as DSL or cables. These users usually do not have a fixed IP but rather a dynamic one. Each time that a user connects to the Internet, the ISP provides him a different IP (dynamic or temporary IPs) from the ISP's pool of the IPs.

The present inventor is disclosing, for the first time, that data related to dynamic IP addresses provided by the ISP may be used in multi-factor authentication.

The present inventor is disclosing methods and apparatus for user authentication, including but not limited to methods and apparatus that utilize dynamic and/or static IP addresses, for user authentication.

### SUMMARY

The present inventor is disclosing, for the first time, that it is possible to utilize one or more ISP account details and/or an ISP-issued temporary/dynamic/re-usable IP address as a factor in a multi-factor user authentication. More specifically, the present inventor is now disclosing for the first time that when authenticating a user; it is possible to determine if there is a correlation and/or correspondence between user-details associated with an authentication request, one or more details of the user's ISP account, and an IP address associated with a user authentication request (for example, an ‘origin’ IP address used by the user's ‘client’ machine when attempting to access a service and/or effect an explicit authentication).

In some examples, the authentication request is issued by and/or received from a user's client machine. Alternatively or additionally, the authentication request is issued by and/or received from a service-provider (for example, an application service provider (ASP) servicing the client machine) and/or mediator entity, for example, providing a service directly or indirectly to the service-provider.

It is now disclosed for the first time a method of providing authentication services. The presently disclosed method includes the steps of: a) handling an authentication request for a user, the authentication request being associated with a candidate IP address and one or more candidate user details; b) determining if the candidate user details and the candidate IP address correspond to and/or correlate with (i.e. completely and/or approximately and/or partially satisfy a predetermined relation) a legitimate ISP account; and c) handling an authentication decision of the user in accordance with results of the determining.

In non-limiting exemplary embodiments, the “handling” of the authentication decision” includes at least one of: (i) generating electronic code indicative of a decision or likelihood of a decision to authenticate the user and/or (ii) effecting an actual authentication to the user machine and/or (iii) effecting an action to not authenticate the user and/or,and/or (iv) sending a directive to authenticate or not and/or data indicative of a directive to authenticate or not to a requesting entity other than the user machine, for example a service provider such as an ASP and/or to a mediator.

It is noted that the authentication request “for the user” is not necessarily received “from the user” and may be, in exemplary embodiments, by received from a service provider and/or mediator.

According to some embodiments, the handling of the authentication decision includes: i) in the event that the candidate user details and the candidate IP address correspond to the legitimate ISP account, authenticating the user.

According to some embodiments, the handling of the authentication decision includes effecting an ASP authentication (i.e. authenticating the client computer by the ASP).

According to some embodiments, the handling of the authentication decision includes issuing an authentication directive to a separate entity (e.g. a directive issued by a mediator such as an IP authentication service to sent to the ASP as a separate entity, a directive issued by an ISP sent to the ASP and/or IP authentic service as a separate entity).

In exemplary embodiments, the presently-disclosed handling of the authentication decision is carried out substantially in real time.

According to some embodiments, the determining of the correspondence (i.e. an absence and/or presence of a correspondence) includes determining if there is an exact or approximate match between: i) the candidate user details and the candidate IP address; and ii) the legitimate ISP account.

According to some embodiments, the determining of the correspondence includes assessing if there is a partial correspondence between: (i) the candidate user details and the candidate IP address; and (ii) die legitimate ISP account.

According to some embodiments, the legitimate ISP account is selected from the group consisting of a traditional ISP account and a one-time ISP account.

According to some embodiments, the determining includes: i) using at least one of one or more the candidate user details and the candidate IP address, effecting a query for ISP account data.

According to some embodiments, the determining further includes: ii) attempting to detect a correlation between the ISP account data and at least one of one or more candidate user details and the candidate IP address.

According to some embodiments, the authentication request is an explicit authentication request (for example, originating from the client machine, for example a machine requesting a service or to open a session with a site and/or application service provider (ASP)).

According to some embodiments, the authentication request is an implicit authentication request (for example, requesting a service without explicitly specifying authentication) associated with a service request.

According to some embodiments, the candidate IP address is a static IP address.

According to some embodiments, the candidate IP address is a dynamic IP address.

In some embodiments, the “handling” of the request includes i) receiving over a wide-area network, by a server, one or more candidate user details from a client machine requesting to be authenticated over a wide-area network; ii) determining an origin IP of said client, thereby obtaining the candidate IP address.

In some embodiments, the handling of the authentication includes authenticating the client machine by the server.

Exemplary user details include but are not limited to a user name, user-account name, user account ID, a password, a user residence detail, a detail indicative of a user-ISP business relationship, a user biographic detail, and a social security number.

According to some embodiments, the method further comprises e) assessing an identity of an ISP from the candidate IP address (i.e. an ISP that issued the candidate IP address), and the determining of the correspondence and/or correlation and/or match is carried out using the assessed ISP.

It is noted that the “assessing” need not be an explicit accessing, and in some embodiments, one or more user details are pre-associated with an ISP (i.e. the user provides a identity of an ISP as user detail). In some embodiments, one or more user details are indicative of an identity of an ISP. In one example, in a certain neighborhood, an ISP has a virtual monopoly, and the user-provided street address is indicative of an identity of an ISP.

In some embodiments, the “determining if there is a match includes issuing an IP Authentication request (i.e. a request to determine if there is a match between the user details and the ISP-issued IP address) over a wide-area network to a third party (for example, to the ISP and/or to an IP authentication service-provider).

In exemplary embodiments, the origin IP (i.e. of the user client machine) is an ISP-issued temporary IP address.

In some embodiments, a database indicative of relationships between active IP addresses and ISP accounts is maintained (for example, by an ISP and/or by an IP authentication service and/or by an ASP), and the determining is effected in accordance with contents of the database.

In some embodiments, the determining includes attempting to locate in said database a specific said ISP account that matches both said candidate IP address and said candidate user details.

In some embodiments, the database (for example, as maintained by an IP authentication service provider and/or a user-service provider) includes data from multiple ISPs.

In some embodiments, the authentication request is forwarded from a third-party service provider (for example, an ISP receives an authentication request from an user-service provider and/or an IP authentication service-provider; for example, an IP authentication service-provider receives an authentication request from an ASP).

It is now disclosed for the first time a system for providing authentication services comprising a) an authentication request handler operative to receive an authentication request associated with a candidate IP address and one or more candidate use details; and b) a request status classifier operative to determine if the candidate user details and the candidate IP address match a legitimate ISP account.

It is now disclosed for the first time a method of providing authentication services comprising: (a) handling an authentication request for a user associated with a candidate IP address and one or more candidate user details; (b) using at least one of the candidate IP address and the one or more candidate user details, effecting a query for ISP account details (i.e. an attempt to access and/or retrieve one or more ISP account details); and c) handling an authentication decision for the user in accordance with results of the query.

According to some embodiments, the candidate IP address is a dynamic IP address.

It is now disclosed for the first time a system for providing authentication services comprising: (a) an authentication request handler operative to receive an authentication request associated with a candidate IP address and one or more candidate use details; and (b) a query-issuer operative to issue a query for ISP account details in accordance with at least one of the candidate IP address and the one or more candidate user details.

It is now disclosed for the first time a method of providing authentication services comprising: a) providing (for example, maintaining and/or receiving) an IP address database (for example, a list or any other data structure) of IP addresses including one or more dynamic IP address); b) receiving an authentication request from a user at a candidate IP address; c) handling authenticating of the authentication in accordance with the contents of dynamic IP addresses.

In exemplary embodiments, the IP address database is a “mixed” database including both static IP addresses as well as dynamic IP addresses.

In some embodiments, the presently disclose method further includes the step of d) determining the candidate IP address in accordance with the authentication request.

It is now disclosed for the first time a method of maintaining a dynamic IP database (i.e. a database with a plurality of “active” dynamic IPs assigned by an ISP such as a database with exclusively dynamic IP and/or a “mixed” database) comprising (a) receiving a database of subscribers (for example. authorized users or users that should be authorized) at least two the subscribers associated with different ISPs; and (b) in accordance with one or more ISP connection events of the subscribers of the database (for example, list), updating a database of dynamic IP addresses.

In some embodiments, the maintaining includes: (i) in accordance with a subscriber ISP logon event, updating the database to include an assigned dynamic IP address of the ISP logon event; and ii) in accordance with a subscriber ISP logoff event, updating the database to remove an assigned dynamic IP address of the ISP logoff event.

In some embodiments, the updating includes updating a dynamic IP database address in accordance with at least one connection event.

It is now disclosed for the first time a method of providing a dynamic IP authentication service to at least one ASP comprising: a) receiving from at least one ASP a database of ASP subscribers (for example, a list); b) receiving data from multiple ISPs indicative of connection events of the subscribers; c) in accordance with the aggregated data, servicing at least one authentication request from an ASP.

In some embodiments, the receiving of the data includes aggregating data indicative of valid dynamic IPs.

In some embodiments, the receiving of the data includes receiving responses to matching queries related to a candidate IP address, one or more candidate user details, and an ISP user account.

It is now disclosed for the first time a system for providing authentication services comprising: a) a dynamic IP address database of dynamic IP addresses; b) a request receiver operative to receive an authentication request for a user (i.e. to receive directly from the user's client machine, or indirectly via a server in communication with the user, and/or to receive a request from an ASP or any other service provider) at a candidate IP address; c) a user authenticator operative to handle the authentication request in accordance with the contents of dynamic IP addresses.

It is now disclosed for the first time a system for updating a database of dynamic IP addresses comprising: a) a database of subscribers (i.e. authorized users or users who should be authorized), at least two subscribers associated with different ISPs; and b) an IP database updater, operative to update an IP address data including at least one dynamic IP address in accordance with ISP connection events of the subscribers of the list.

These and further embodiments will be apparent from the detailed description and examples that follow.

### BRIEF DESCRIPTION OF THE DRAWINGS

FIG. 1A provides a block diagram of an exemplary system for authenticating a client computer.

FIG. 1B provides a block diagram of an exemplary method for authenticating a client computer.

FIG. 2-3 provides flow-charts of exemplary routines for user authentication disclosed in accordance with some embodiments of the present invention.

FIG. 4 provides a flow-chart of an exemplary routine or maintaining a database of dynamic IP addresses.

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to”), rather than the mandatory sense (i.e. meaning “must”).

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for providing authentication services is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

The present inventor is now disclosing for the first time a method and system for authenticating users that employs dynamic IPs issued by an ISP.

Preliminary Discussion

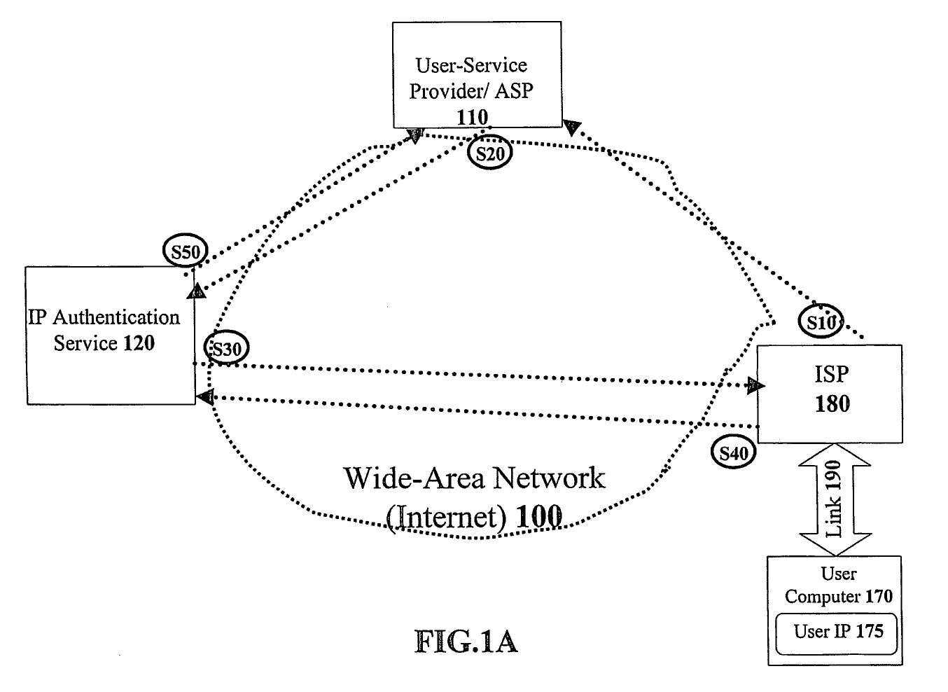

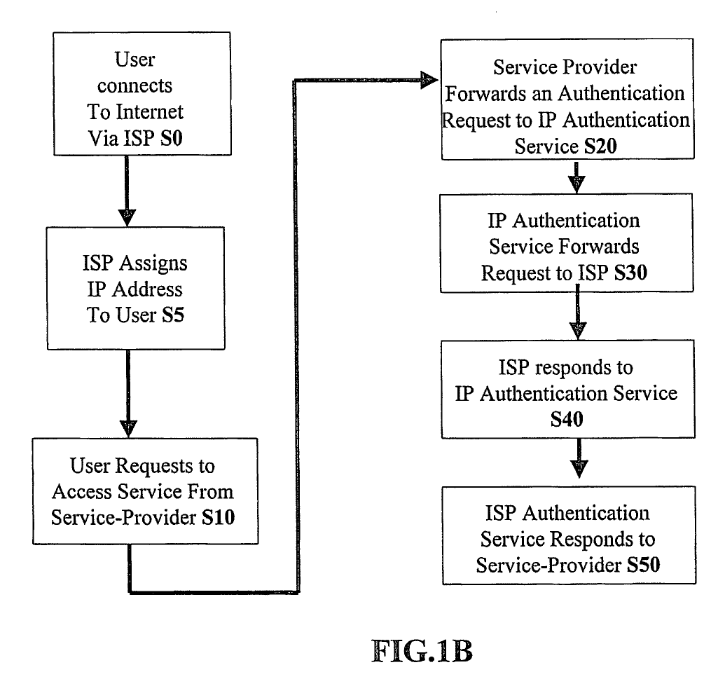

FIGS. 1A-1B respectively provide block diagrams of an exemplary system and exemplary method for authenticating a user computer in accordance with exemplary embodiments of the present invention. As illustrated in these figures, a user computer 170 or “client machine” connects (S0) to the Internet 100 via an ISP (SO) via a link 190. It is noted that the teachings of the present invention apply to user computers 170 connected using any connection method known in the art, including but not limited to DSL access, cable access, and dial-up access.

When the user connects to the ISP 180, the ISP 180 assigns (S5) the user a dynamic IP 175, for example, from a pool of IPs. It is noted that FIGS. 1A-1B relate to the specific case of a single user computer 170 connected to an ISP via a link 190, though it is appreciated that the teachings of the present invention apply to the case of a plurality of user computers (for example, in a home or business computer network—not shown) sharing a single link 190 (for example, via a router and modem) to the ISP, logged in using a single ISP account.

The term ISP 180 is used in a broad sense, to include both subscription-based or “traditional” ISPs 180 (for example, cable and/or phone and/or telecommunication companies or their representatives which offer ongoing access to the Internet for a per period fee, usually a monthly or annual fee) as well as “one time” ISPs (i.e. public wireless/WiFi networks which may offer “temporary” or “one-time” or “multiple access” accounts—these networks are often deployed in coffee shops, airports, etc). It is noted that when logged into the internet via an ISP, the user computer 170 is associated with an IP address, either an ISP-assigned dynamic or temporary ISP, or a permanent IP address either assigned by the ISP or a permanent IP address whose existence is known to the ISP.

The term “ISP account” is also used in a broad sense, and is not limited to accounts issued by traditional ISPs. Thus, one example of ISP accounts are one-time accounts associated with ISP account details (for example, a name of the user, credit card data of the user, etc).

As used herein, a “legitimate” ISP account is an account which may be verified (either directly and/or indirectly using a mediator) by the ISP.

Step S10

Once connected to the Internet 100 via the ISP 180, the user computer 170 issues (S10), via the wide-area network 100, a request for a service from a user-service provider (ASP) 110 (i.e. the machine(s) which provide the service to the user machine 170, for example, a server or a cluster of servers). In exemplary embodiments, this request may be issued by a web browser residing on the user's computer 170.

For example, the request might be an authentication request to authenticate the client machine 170, for example, to open an authenticated session between the user-service provider (ASP) 110 and the client machine. In one non-limiting example, the client machine 170 issues a request to the service-provider 110 to be authenticated to “log in” to a financial (e.g. banking and/or an account for trading marketable securities) account and/or an e-commerce account, and to open a session between the client machine 170 and the service provider 110.

In another non-limiting example, the request might be a request to provide web content to the client machine 170, for example, subscription-based content provided only to certain users. In yet another non-limiting example, the request might be a request to provide some other service to the client machine 170, for example, a proxy service and/or a value added service (for example, embedding relevant links into content served to the client machine 170, a security-oriented value-added service that, for example, removes viruses from content served to the client machine 170, or any other value added service).

Thus, the user-service provider (ASP) 110 (i.e. the server or cluster of servers, or computer network which provides a service to the client machine 170), may be, for example, an e-commerce site, a banking site, a content re-sale or content distribution site, a security-providing site, or any other service provider.

In one example, it is desired for the user-service provider (ASP) 100 to provide a specific service selectively to certain users For example, only certain client machines are allowed to use the service, or alternatively, different client machines receive different levels of service in accordance with a “subscriber status” determined by an identity or status of a client machine 170.

It is noted that typically the service and/or authentication request of S20 includes one or more user details which identify the user and/or the user machine that is requesting S20 authentication and/or the service. Exemplary “user details” include but are not limited to a user name, a PIN and/or password, a user residence detail (for example, zip code and/or address), a user personal details (for example, mother's maiden name or other details typically known only to the user or the user's close associate—such details are often used by service providers such as ISPs to verify ownership of a service account such as an ISP account), a use's biographic detail (for example, date of birth, city of birth, mother's maiden name, and a user's social security number. Including the user details in die actual request and/or associating the user details with the request provides one or more “factors” of the multi-factor authentication request.

In some embodiments, the request S10 for service and/or authentication is a browser-generated request. Alternatively or additionally, the request for service and/or authentication is a web service call, for example, using a text-based (for example, a protocol from the HTTP family) and/or a binary protocol.

In some embodiments, the user details may be sent S10 as encrypted data from the user computer 170 to the service provider 110. As used herein, the details provided to the service provider 110 are referred to as “candidate user details” associated with a request that may or may not be met and/or authenticated

Step S20

According to the example of FIGS. 1A-1B, after receiving the user details, the service provide forwards S20, to an IP authentication service 120, data indicative of the user details along with detail indicative of “candidate” user IP address 175 (i.e. indicative of the IP of the user computer 170). Typically, the candidate user IP address 175 will be the temporary and/or dynamic IP address that has been assigned to the machine (or machine cluster) by the ISP 180.

In some embodiments, the service provider 110 extracts the user IP address 175 from the request (or another request from the same machine and/or machine cluster) using various techniques that are known in the art, though it is appreciated that an entity other than the service provider 110 may determine the candidate user IP address.

Upon receiving the user IP address 175 and the user details, the IP authentication service 120 effects a determination if the user details and the user IP address 175 of the client machine match a legitimate ISP account.

It is noted that when users log into their ISP accounts, the ISP assigns the user machine 170 an IP address (see step S5). Typically, the ISP maintain databases including the assigned IP addresses, to which user the IP address has been assigned, and various “account details” of the user's ISP account. Various embodiments of the present invention are predicated on the assumption that in many situations, there will be a correlation between user details provided when logging into an account and/or access a specific subscription-based service, and details associated with the use's ISP account. Thus, in exemplary embodiments, there is some sort of correlation between the “user details” provided in S10, and the “account details” of the user's ISP account.

Thus, it is possible to authenticate the user by determining if there is a “match” between the user details, the user IP 175 from which the user details are provided, and a user ISP account.

Steps S30-S50

In one non-limiting example, it is possible to query S30 the ISP for the match—i.e. to query the ISP if the user IP address 175 assigned by the ISP is associated with an ISP account that matches the user's details. In the example of FIG. 1, after receiving this query S30, the ISP 180 responds S40 to the IP authentication service 120 with data indicating whether or not the candidate user details/candidate use IP 175 pair should be authenticated. The IP authentication service then forwards S50 these results to the user-service provider (ASP) 110 which authenticates and/or provides service to the user 170 (or denies authentication and/or service to the users) in accordance with the received S50 results.

It is noted that the user details serve as a first factor for authenticating the user, while the ISP-assigned IP address 175 serves as a second factor for authenticating the user.

It is noted that although the presently disclosed system and method have been expressed in the context of “two” factor authentication, this is not a restriction, and embodiments where the teachings of the present invention are employed in a token-based system (for example, a USB authentication token) (or in any other two-factor authentication system) to provide multi-factor authentication (i.e. more than two factors) are also within the scope of the present invention.

Discussion of Some Alternate Implementations

In the non-limiting examples depicted in FIGS. 1A-1B, specific tasks were attributed to the user-service provide 110, the IP Authentication Service 120 and the ISP 180. This is because in certain situations, it is impractical for ASPs 110 to, in an unassisted manner, resolve a dynamic IP with a user account without using an authentication service, because it requires establishment of business and technical relationships with many ISPs in many different geographical areas.

Nevertheless, it is noted that this is not the only possible “division of labor” and there is no explicit requirement for an IP Authentication Service 120. In one example, instead of the IP authentication service 120 querying the ISP 180 about a specific candidate user IP 175 and candidate user details as to whether or not they match, the IP authentication service 120 (or the user-service provider (ASP) 110) may maintain a database indicative of relationships between ISP-issued temporary/dynamic IPs and user details. This database may be maintained by receiving data updates “pushed” from the ISP 180. According to this example, upon receiving as service and/or authentication request S10, it is possible to authenticate the user without explicitly contacting the ISP 180 with an explicit query for that particular user

In another example, the user-service provider (ASP) 110 may provide the IP authentication service 120 and/or one or more ISPs 180 (or alternatively, the IP authentication service 120 may provide the list to the ISP 180) with a list of registered users of the service. After receiving the list, notifications can be made as to the service provider 110 and/or the authentication service 120 as to when certain users log onto or out of their ISP accounts. Thus, the service provider 110 and/or the authentication service 120 may receive data indicative of an ‘active valid IP list’ of “active temporary/dynamic IPs (this data may be provided, for example, in the form of ISP logon/logoff notifications). According to this example, upon receiving a service and/or authentication request S10 from a user computer 170, it is not necessary to effect a matching query for the candidate user IP 175 and user details. Rather, it is sufficient to verify that the candidate IP 175 matches an IP of the ‘active IP list. ’

It is noted that typically (but not always), the user base (or prospective “candidate” users) of a user-service will include users from more than one ISP (for example, some users access the Internet using Verizon, other users access the Internet using Comcast, etc). Thus, in some embodiments, the user-service provider (ASP) 110 and/or the IP authentication server 120 may maintain data related to ISP accounts and/or to valid ISP-issued IPs from a plurality of IPs.

In another example, there is no “independent” IP authentication service 120 provided, and the user-service provider (ASP) 110 directly contacts one or more ISPs 180 without employing an IP authentication service 120 as an intermediary. One obstacle that may need to be overcome is knowing which IP 180 to contact to query a particular user. This may be overcome in a number of ways. In one example, a query for a particular candidate IP 175 and candidate user details are sent to a plurality of IPs 180, and the user is authenticated if at least one IP 180 replies with data indicating that the candidate IP 175 corresponds to a valid/authenticatable user.

According to another example, different heuristics may be employed about which ISP to contact—for example, it may be known that different ISPs have different prefixes for the various dynamic IP addresses they issue S5 users after the user connects S10 to the Internet.

Discussion of Routines Implemented by the User-Service Provider (ASP) 110 In Exemplary Embodiments

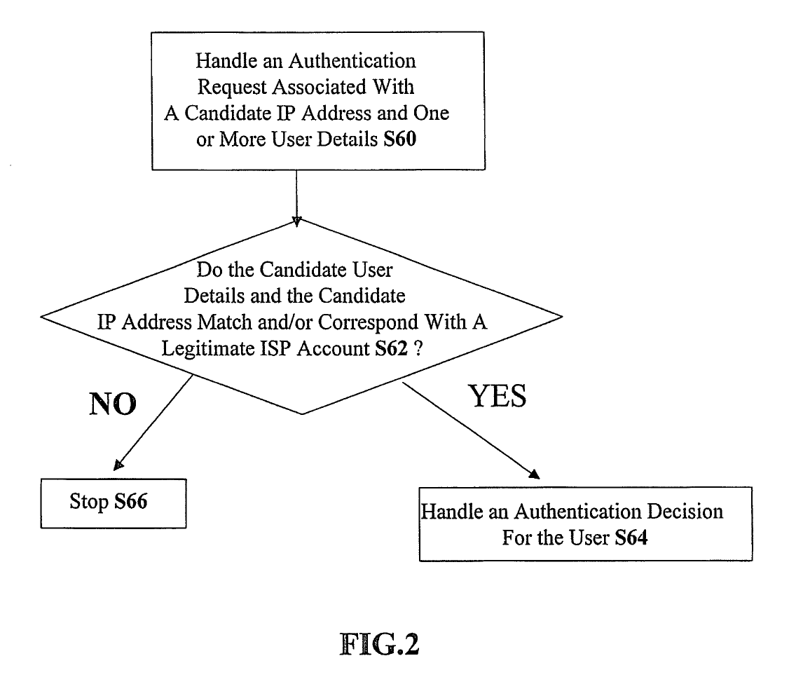

In some embodiments, the user-service provider (ASP) 110 may implement the routine described in FIG. 2. Thus, in step S60, the user-service provider (ASP) 110 “handles” an authentication request (for example, generated in S10) associated with a candidate IP address (i.e. User IP 175) and one or more user details (for example, user details presented to the user-service provider (ASP) 110). As used herein, an “authentication request” (either an explicit authentication request such as an account login or an implicit authentication request associated with a request for a selectively-provided, for example subscription-based, service) includes one or more candidate user details (i.e. candidate implying the user wishing to be authenticated), and a candidate IP address 175 (i.e. the ISP-assigned temporary/dynamic IP address of the candidate user) (i.e. an “origin” of the request).

In some embodiments, “handling” of an authentication request may entail receiving (over the wide-area network 100), by a server machine of the user-service provider (ASP) 110, one or more candidate details from a client machine 170 requesting to be authenticated—for example, receiving an explicit user login request including one or more user details from an origin IP of the client machine 170.

After receiving the authentication request (explicit and/or implicit authentication request), the user-service provide 110 may determine S62 whether or not the candidate user details and the candidate IP address match a legitimate ISP account 62—for example, by forwarding the authentication request to an IP authentication service 120 and/or to one or more ISPs 180. Once a response is received (for example, from S50 an IP authentication server 120), if it is determined (by forwarding the authentication request and receiving a response) that there is a match with a legitimate ISP), the client machine may be authenticated S64 and the request may be authorized S64 (unconditionally, or conditionally in accordance with one or more other factors, such as a match between a user ID and a password). In exemplary embodiments, the authorization (unconditionally, or conditionally in accordance with one or more other factors, such as a match between a user ID and a password). S64 is carried out by the user-service provide by, for example, opening an authorized session with the client machine 170 and/or providing the requested service requiring authorization (for example, service content or any other value-added service) to the client machine.

Although the method of FIG. 2, as implemented by the user service provider 110, was described in terms of forwarding the authentication request, it is noted that this is not a limitation, and in some embodiments, the determining of whether or not there is a match includes effecting a database lookup (for example, a database that includes active dynamic IPs issued by an ISP 180 mapped, directly or indirectly, to user details) by the user service provider 110.

In exemplary embodiments, the routine includes forwarding a request to more than one ISP, or determining an ISP 180 associated with the candidate IP address 175.

Discussion of Routines Implemented by the IP Authentication Service-Provider 120 In Exemplary Embodiments

In exemplary embodiments, the routine of FIG. 2 may be implemented by the IP authentication service-provider 120. Thus, the IP Authentication Service-Provider may “handle” S60 an authentication request including a candidate IP address and one or more candidate user details by receiving data indicative of the request from the use-service provider 110 (or another third-party). The IP Authentication Service provider may then either then seek a match S62 (i.e. to determine if the candidate user details and die candidate IP address match a legitimate ISP account) by either (a) effecting a database lookup, and/or (b) forwarding a request to attempt to match die candidate user details and IP address with a legitimate ISP account.

In accordance with the results of the determining, the IP authentication service-provider 120 may forward S64 to the user service-provider 110 data indicative of a directive to authenticate the user.

In exemplary embodiments, the routine includes forwarding a request to more than one ISP, or determining an ISP 180 associated with the candidate IP address 175.

Discussion of Routines Implemented by the ISP 180

In exemplary embodiments, the routine of FIG. 2 may be implemented by an ISP 180. Thus, the ISP may “handle” S60 an authentication request including a candidate IP address and one or more candidate user details by receiving data indicative of the request from the user-service provider (ASP) 110 and/or from the IP Authentication Service 120 provider (or another third-party). The ISP 180 may then seek a match S62 (i.e. to determine if the candidate user details and the candidate IP address 175 match a legitimate ISP account) by either effecting a database lookup in a database that includes ISP account data, temporary/dynamic IPs issued by the ISP, and user details associated with the ISP accounts.

After effecting the determining, the ISP 180 may or may not authenticate the user S64 by forwarding S64 to the user service-provider 110 data and/or to the IP authentication service provider 120 data indicative of a directive to authenticate (or not) the user.

Maintaining and Using a Database/List of Authorized Dynamic IP Addresses

In some embodiments, it is not required to explicitly effect a lookup/query of candidate user details and a candidate dynamic IP in order to determine if there is a corresponding ISP account to authorize the users (including but not limited to embodiments that relate to Example 2, described below).

Rather, in some embodiments of the present invention, a list or database of “authorized” dynamic IP address is maintained in accordance with the list of registered or allowed users.

More specifically, a database or list of allowed users is provided (for example to an ISP and/or an IP authorization service). Concomitantly, a database or list of “allowable” or “authorized” dynamic IP addresses is maintained in accordance with the list of allowable users Thus, in exemplary embodiments, whenever an “allowed” user connects to the Internet via his ISP (and is assigned a dynamic IP address), that user's assigned dynamic IP address is added to the database of list of allowable IP addresses. Similarly, whenever the “allowed” user logs out of his ISP account, the previously-assigned dynamic IP is deleted from the “authorized” database of list of allowed IP addresses.

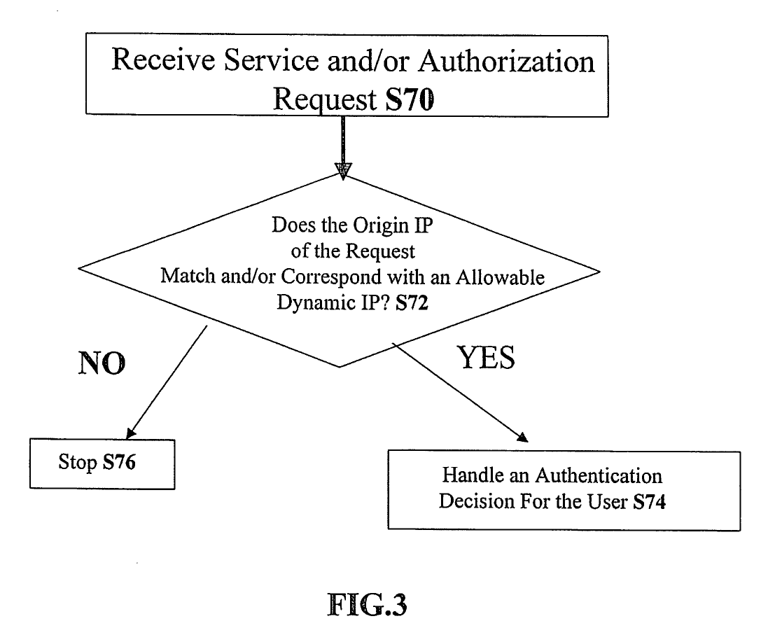

It is disclosed that this database of “allowable” IP addresses is may be useful, for example, to the ASP 110. More specifically, and with reference to FIG. 3, when requests for authorization and/or service are received S70 (for example, by the ASP 110 or by the IP Authorization Service 120 or by the ISP 180), a determination is made S72 (e.g. by the ASP 110 or by the IP Authorization Service 120 or by the ISP 180) if the origin IP (for example, extracted from the service and/or authentication request) matches an “allowable” dynamic IP address (i.e. an IP address in the database or list of allowable IP addresses).

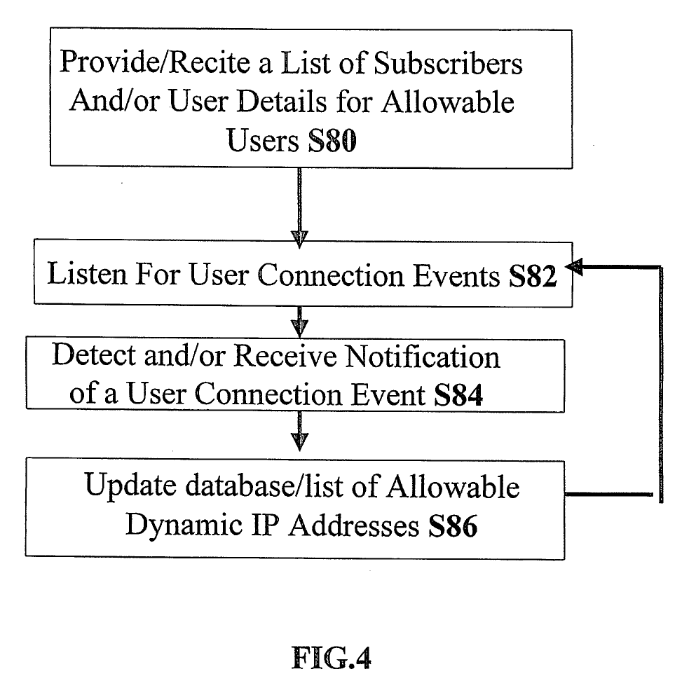

FIG. 4 provides a flow-chart of an exemplary routine for maintaining the database or list of allowable IP addresses. A list of “subscribers” (or allowable users—i.e. including user details and/or ISP account data for each subscriber) is provided and/or received S80 (for example, by the ISP and/or by the IP Authentication Service 120 or by the ASP 110). In exemplary embodiments, the list of subscribers includes subscribers of different ISPs 180.

According to the routine of FIG. 4, user connection events S82 (i.e. ISP logon events where the user logs via connection 190 to the ISP 180 and/or Isp logoff events) are listened for and/or monitored S82. When such an event is detected and/or notification of the event is received S84, the list of allowable dynamic IP addresses is updated S86.Thus, as discussed above, when a user logs onto the ISP (i.e. connects to the ISP and is assigned a dynamic IP), the additional dynamic IP address may be added to the list/database of allowable dynamic IP addresses, and when the user disconnects from the ISP, the dynamic IP address is removed.

The following examples are to be considered merely as illustrative and non-limiting in nature. It will be apparent to one skilled in the art to which the present invention pertains that many modifications, permutations, and variations may be made without departing from the scope of the invention.

### EXAMPLE 1

### Accessing an Online Bank Account

1) When registering to the eBanking service, the user specifies to the bank which ISP he is using to connect to the Internet and what is his account name at the ISP. Alternatively the user may register to the authentication service and provide his ISP account details to the authentication service instead of giving them to the bank. In this case the user will get the user ID from the authentication service and he will give his ID to the bank.
2) A User logs-in to the ISP using his ISP username and password. The User is assigned by the ISP either has a static IP address or a dynamic one.
3) The User then connects to his Bank's website where he can access his bank account.
4) The Bank requests a separate username and password from the User in order to log in to his bank account.
5) The Bank creates an IP Authentication Request which it sends to the IP Authentication Service available on the Internet. The Request either the user ID at the registration service or the user. ISP account details (depend on the working mode that was chosen in section 1) and the IP address from which the User is communicating with the Bank.
6) The authentication service forward the request to the users's ISP.
7) The ISP checks the identifying information provided against the IP address it assigned the User. If a valid relationship is established, then a positive IP Authentication Response is sent to the IP Authentication Service.
8) The IP Authentication Service forwards the Response to the Bank, which uses it as a second authentication factor (hence two-factor authentication).
9) If both username and password information provided to the Bank by the User and the verification information provided by the IP Authentication Service are valid, then the user is granted access to his bank account.

### EXAMPLE 2

### A Secure Surfing Service

Another embodiment of the invention relates to a service that provides a “secure surfing” service, over a network, to a group of paying users, using a web-based proxy server. The server filters the users' web traffic and remove unwanted or bad code without asking the users to provide a user name and password, while, nevertheless preventing non-subscribers from accessing the service.
1) When registering to the “secure surfing” service, the user specifies which ISP he is using to connect to the Internet and what is his account name at the ISP. This information is saved in the “paying users” list of the service.
2) The user configures his WEB browser to browse through the proxy server of the “secure surfing” service.
3) A user logs-in to the ISP using his ISP username and password. The User is assigned by the ISP either has a static IP address or a dynamic one.
4) When the user starts to surf the WEB the “secure surfing” proxy server gets a request from the user browser.
5) When the proxy server is started, it creates a list of valid IPs that service is provided for them. By default this list is empty.
6) When the proxy server gets a WEB request, it first checks if the source IP of the request exist in its valid IP list
7) If the IP exist in the valid IP list, the request is handled.
8) If the IP doesn't exist in the valid IP list, the proxy server request the IP authentication service to find the ISP account name of the source IP.
9) The IP authentication service may first determine the owner ISP of the IP, and then it forwards a request to the owner ISP.
10) The ISP returns the user account name that the IP is currently assigned to.
11) The authentication service returns the account name to the proxy server.
12) The proxy server search in the “paying user” list if the account name belongs to a paying user.
13) If the answer is true, the IP is added to the valid IP list and the original request is handled.
14) The proxy server may refresh the valid IP after a time period, so if a paying user disconnects from the Internet and the ISP provides his IP address to another user that connects just after that, the new user will not be able to user the service if he is not a paying user.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The presently-disclosed systems may be implemented in software, hardware, or any combination thereof.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of providing authentication services, the method comprising:
a) handling an authentication request for a user, said authentication request being associated with a candidate IP address and one or more candidate user details;
b) determining if said candidate user details and said candidate IP address correspond to a legitimate ISP account; and
c) handling an authentication decision for said user in accordance with results of said determining.

2) The method of claim 1 wherein said handling of said authentication decision includes:
i) in the event that said candidate user details and said candidate IP address correspond to said legitimate ISP account, authenticating said user.

3) The method of claim 2 wherein said handling of said authentication decision includes effecting an ASP authentication.

4) The method of claim 1 wherein said handling of said authentication decision includes issuing an authentication directive to a separate entity.

5) The method of claim 1 wherein said determining of said correspondence includes determining if there is an exact or approximate match between:
i) at least some said candidate user details and said candidate IP address; and
ii) said legitimate ISP account.

6) The method of claim 1 wherein said determining of said correspondence includes assessing if there is a partial correspondence between:
i) at least some said candidate user details and said candidate IP address; and
ii) said legitimate ISP account.

7) The method of claim 1 wherein said legitimate ISP account is selected from the group consisting of a traditional ISP account and a one-time ISP account.

8) The method of claim 1 wherein said determining includes:
i) using at least one of one or more said candidate user details and said candidate IP address, effecting a query for ISP account data.

9) The method of claim 8 wherein said determining further includes:
ii) attempting to detect a correlation between said ISP account data and at least one of one or more said candidate user details and said candidate IP address.

10) The method of claim 1 wherein said authentication request is an explicit authentication request.

11) The method of claim 1 wherein said authentication request is an implicit authentication request associated with a service request.

12) The method of claim 1 wherein said candidate IP address is a static IP address.

13) The method of claim 1 wherein said candidate IP address is a dynamic IP address.

14) The method of claim 1 wherein said handling of said request includes:
i) receiving over a wide-area network, by a server, one or more said candidate user details from a client machine requesting to be authenticated over a wide-area network; and
ii) determining an origin IP of said client, thereby obtaining said candidate dynamic IP address.

15) The method of claim 14 wherein said handling of said authentication includes authenticating said client machine by said server.

16) The method of claim 1 wherein at least one said user detail is selected from the group consisting of a user name, a password, a user residence detail, a detail indicative of a user-ISP business relationship, a user biographic detail, and a social security number.

17) The method of claim 1 further comprising:
e) assessing an identity of an ISP from said candidate IP address,
wherein said determining of said correspondence is carried out using said assessed ISP.

18) The method of claim 1 wherein said determining includes issuing an ISP Authentication request over a wide-area network to a third party.

19) The method of claim 18 wherein said third party is selected from the group consisting of an ISP and an IP authentication service provider.

20) The method of claim 1, the method further comprising:
c) maintaining a database indicative of relationships between active IP addresses and ISP accounts,
wherein said determining is effected in accordance with contents of said database.

21) The method of claim 20 wherein said determining includes attempting to locate in said database a specific said ISP account that corresponds with both said candidate IP address and said candidate user details.

22) The method of claim 20 wherein said database includes data from multiple ISPs.

23) The method of claim 1 wherein said authentication request is received from a service provider.

24) A system for providing authentication services, the system comprising:
a) an authentication request handler operative to receive an authentication request associated with a candidate IP address and one or more candidate use details; and
b) an request status classifier operative to determine if said candidate user details and said candidate IP address correspond to a legitimate ISP account.

25) A method of providing authentication services, the method comprising:
a) handling an authentication request for a user associated with a candidate IP address and one or more candidate user details;
b) using at least one of said candidate IP address and said one or more candidate user details, effecting a query for ISP account details; and
c) handling an authentication decision of said user in accordance with results of said query.

26) The method of claim 1 wherein said candidate IP address is a dynamic IP address.

27) A system for providing authentication services, the system comprising:
a) an authentication request handler operative to receive an authentication request associated with a candidate IP address and one or more candidate use details; and
b) a query-issuer operative to issue a query for ISP account details in accordance with at least one of said candidate IP address and said one or more candidate user details.

28) A method of providing authentication services comprising:
a) providing an IP address database including a plurality of IP addresses including at least one dynamic IP addresses;
b) receiving an authentication request for a user associated with a candidate IP address; and
c) handling authentication of said authentication request in accordance with said contents of said database.

29) The method of claim 28 further comprising:
d) determining said candidate IP address in accordance with said authentication request.

30) A method of maintaining an IP database, the method comprising:
a) receiving a database of subscribers, at least two said subscribers associated with different ISPs; and
b) in accordance with one or more ISP connection events of said subscribers of said database, updating an IP database including a plurality of IP addresses including at least one dynamic IP address.

31) The method of claim 30 wherein said maintaining includes:
i) in accordance with a subscriber ISP logon event, updated said database to include an assigned said dynamic IP address of said ISP logon event; and
ii) in accordance with a subscriber ISP logoff event, updated said database to remove an assigned said dynamic IP address of said ISP logoff event.

33) The method of claim 30 wherein said updating includes updating a dynamic IP database address in accordance with at least one said connection event.

34) A method of providing a dynamic IP authentication service to at least one ASP comprising:
a) receiving from at least one ASP a database of ASP subscribers;
b) receiving data from multiple ISPs indicative of connection events of said subscribers; and
c) in accordance with said aggregated data, servicing at least one authentication request from an ASP.

35) The method of claim 34 wherein said receiving of said data includes aggregating data indicative of valid dynamic IPs.

36) The method of claim 34 wherein said receiving of said data includes receiving responses to matching queries related to a candidate IP address, one or more candidate user details, and an ISP user account.

37) A system for providing authentication services comprising:
a) an IP address database including a plurality of IP addresses including at least one dynamic IP address;
b) a request receiver operative to receive an authentication request for a user associated with a candidate IP address;
c) a user authenticator operative to handle authentication of said authentication request in accordance with said contents of said database.

38) A system for updating a database of dynamic IP addresses, the system comprising:
a) a database of subscribers, at least two said subscribers associated with different ISPs; and
b) an IP database updater, operative to update an IP address database including at least one dynamic IP address in accordance with one or more ISP connection events of said subscribers of said database.
